(19) United States
(12) Patent Application Publication
(10) Pub. No.: US 2016/0055743 A1
(43) Pub. Date: Feb. 25, 2016

(54) Congo: System and Method of Transportation Using Carrier Vehicles and Personal Transport Vehicles

(71) Applicant: Sunder Rathnavelu Raj, Marlboro, NJ (US)

(72) Inventor: Sunder Rathnavelu Raj, Marlboro, NJ (US)

(21) Appl. No.: 14/467,000

(22) Filed: Aug. 23, 2014

(51) Int. Cl. G08G 1/00; G06Q 10/10

(52) U.S. Cl. CPC G08G 1/00; G06Q 10/1097

(57) ABSTRACT

In accordance with one embodiment a person uses a personal transport vehicle to ride to a pickup point. At the pickup point, both the person and his/her personal transport vehicle get on a carrier vehicle. Carrier vehicle transports them from the pickup point to the drop off point. While in transit, the carrier vehicle also recharges the battery on the personal transport vehicle. Hence the acronym CONGO, stands for Charge ON the GO. At the drop off point person gets off the carrier vehicle along with the personal transport vehicle and covers the remainder of the distance to the desired destination on the personal transport vehicle. According to one embodiment persons use an application software on a smart phone to communicate their requests for a ride to a scheduler system and receive directions therefrom. A scheduler system receives requests and status updates from persons and carrier vehicles and controls the overall operation of the transportation system.

### BACKGROUND

### Prior Art and References

The following is a listing of some prior art that appears relevant:
1. US20110218697A1, Vehicle, system and method for mass transit, publication date Sep. 8, 2011, Inventor: Netanel Goldberg
2. U.S. Pat. No. 5,797,330A1, Mass transit system, publication date Aug. 25, 1998, inventor: Zhengzhong Li
3. US20070214995A1, Vehicle, Process and Systme for Mass Transportation, publication date Sep. 20, 2007, Inventors: Mark Publicover
4. US 2005247231A1, Track-guided transport system and method for controlling cars of a track-guided transport system, publication date Nov. 10, 2005, Inventor Werner Fischer
5. U.S. Pat. No. 4,632,038A, Monorail Vehicular System, publication date Dec. 30, 1986, David L. Lawrence
6. U.S. Pat. No. 6,012,396: Electric rail transportation system, vehicle, and rail used in the transportation system, publication date: Jan. 11, 2000, inventor: Bruce DeLeon Schulz
7. US 20070114078A1, Super hybrid and enhanced electric cars, publication date: May 24, 2007, inventors: Esther Ososanya, Daykaker Karter, Steven Omoijuanfo, Oluwakayode Bamiduro

### Non-Patent Literature Documents

(a) Emilia Istrate, Robert Puentes, and Adie Tomer, State of Metropolitan America, Brookings Institute “Chapter IX—Commuting”.
(b) Report by IBM Corp “The Globalization of Traffic Congestion: IBM 2010 Commuter Pain Survey”
(c) Automobile Association of America, “Your Driving Costs—How Much Are You Really Paying to drive?” 2014 Edition.
(d) American Public Transportation Association “2010 Public Transportation Fact Book” 61^{st} Edition.
(e) Elizabeth Roberto, Transportation Reform Series for the Metropolitan Policy Program at Brookings. “Commuting to Opportunity: The working Poor and Commuting in the United States” February 2008

### BACKGROUND

An efficient transportation system is the lifeblood of any modern society, and is key to a well-functioning economy. Most of the urban and suburban areas today suffer from very poor transportation facilities. This is a particular problem for commuters who waste many hours each day from spotty mass transit service, or driving in slow moving traffic facing pollution and resulting stress. These issues are well illustrated in reference (b) IBM Corp “The Globalization of Traffic Congestion: IBM 2010 Commuter Pain Survey” in which 30% of respondents report increased stress from driving. 57% felt it harmed their health. Mass transit is often thought to be the answer to problems with traffic congestion, but current mass transit systems, despite being heavily subsidized, provide a spotty service at best and are still fairly expensive. This explains why according to the report cited in reference (a), 74% of commuters in the USA still travel alone by car. One of the key reasons for the high cost of mass transit is the very low average occupancy of public transit busses and trains. A report by the American Public Transportation Institute in reference (d), the average occupancy of a public transit bus is only 18.3%.

Owning and operating a car continues to be very expensive, According to the 2014 AAA report titled “Your Driving Costs: how much are you really paying to drive?” reference (c), an average driver spends 59.2 c/mile that corresponds to $8800 annually for owning and operating a car.

Any new solution for public transit should therefore have some of the following characteristics to be viable:
1. Require low capital expenditure: governments around the world are low on budgets, any solution that needs a big capital outlay will not succeed on a larger scale.
2. Needs to address the commuter pain aspect, commuters who take the mass transit are more relaxed and are able to use the commute time to relax and to work because they are not driving. This aspect of mass transit should form part of any new solution.
3. Cost of ownership should be kept low. Current cost of owning a car keeps it out of reach of many low income families. 52% of households in the US have an annual income of $50K or less. Annual cost of owning a car forms almost 17.6% of this. For the 28% households with an income of $25K or less, the cost of owning a car is a whopping 35% of their annual income.
4. Require minimal new infrastructure. Many solutions such as pure electric cars or monorail systems need a fairly large new infrastructure, such as charging stations to be put in place. This makes these solutions impractical in many of the already dense and congested city areas. A solution that uses infrastructure that is already in place is preferable.
5. Operating the transit system should be cost effective and profitable. It is very important to improve occupancy numbers so that operational expenses are low and the solution becomes viable.

While characteristics to look for in a good solution are almost self-evident, so far none of the prior-art solutions proposed meet the needed characteristics. Several solutions have been proposed. For example US 2005247231A, U.S. Pat. Nos. 4,632,038A, 6,012,396 describe various types of new monorail systems or vehicles that need new infrastructure to be put in place. Any solution that needs major new investments in infrastructure will not likely succeed on a larger scale due to the major investments needed and governments around the world are short on funds.

US20110218697A1 Goldberg describes a system wherein passenger modules are attached, transported and transferred by a rail-base. Passenger modules are transferred between rail bases without the passenger having to exit the module. This solution again requires development of major new infrastructure, especially at the hubs. Additional infrastructure is needed to refuel or recharge the passenger modules separate from the transportation infrastructure. This is impractical for most of the cities around the world which are short on budgets.

US20070114078A1 describes an enhanced hybrid car. This solution and other such solutions that enhance the fuel economy of existing automobiles mainly address the fuel consumption of conventional cars. They do not solve the traffic congestion and the stress of driving under heavy traffic conditions. They also do not address the high cost of ownership.

We can conclude by these facts that prior art methods suffer from several disadvantages. In accordance with one embodiment describes a new method of transportation that overcomes many of the disadvantages of prior art solutions whilst not requiring heavy investments in infrastructure.

### SUMMARY

In accordance with one embodiment a person uses a personal transport vehicle to ride to a pickup point. At the pickup point, both the person and his/her personal transport vehicle get on a carrier vehicle. Carrier vehicle transports them from the pickup point to the drop off point. While in transit, the carrier vehicle also recharges the battery on the personal transport vehicle. Hence the acronym CONGO, stands for Charge ON the GO. At the drop off point person gets off the carrier vehicle along with the personal transport vehicle and covers the remainder of the distance to the desired destination on the personal transport vehicle. According to one embodiment persons use an application software on a smart phone to communicate their requests for a ride to a scheduler system and receive directions therefrom. A scheduler system receives requests and status updates from persons and carrier vehicles and controls the overall operation of the transportation system.

### Advantages

Accordingly several advantages of one or more aspects are as follows: reduces cost of ownership and driving stress compared to travelling by car. Overall pollution levels are also reduced. As compared to mass transit, the occupancy rates are much higher resulting in less operational cost. Overall transit speed and comfort are better compared to existing mass transit systems due to pickup points being spaced farther apart and optimal scheduling achieved by the scheduler system. One or more aspects of the embodiments also reduce the number of routes compared to existing mass transit system thus reducing the complexity and cost of maintaining the system. Investments in additional infrastructure are very minimal due to the fact that it uses existing infrastructure and in fact reduces use of existing infrastructure such as parking that were needed in existing systems.

### BRIEF DESCRIPTION OF THE SEVERAL VIEWS OF THE DRAWING

FIG. 1 Shows one embodiment of a carrier vehicle capable of transporting persons and personal transport vehicles in separate areas of the carrier vehicle.

FIG. 2 Shows a second embodiment wherein persons and personal transport vehicles are carried in the trailer portion of the carrier vehicle.

FIG. 3 Shows a third embodiment of a carrier vehicle wherein multiple trailers are attached to a single truck.

FIG. 4 Illustrates the overall operation of one embodiment.

### DETAILED DESCRIPTION

In the following description, for purposes of explanation, specific nomenclature is set forth to provide a thorough understanding of the embodiment. However it will be apparent to one skilled in the art that these specific details may not be required to practice any of the embodiments.

In accordance with one embodiment a carrier vehicle is used to transport persons and their personal transport vehicles. Persons ride their personal transport vehicles to get to the pickup point. Since persons and their personal transport vehicles travel together, the need for parking at the pickup and drop off points is eliminated. This is an advantage over many of the prior art systems which require infrastructure to park at the pickup points. They also use their personal transport vehicles to reach their destination point from the drop off point.

Personal transport vehicles have a rechargeable battery that is recharged during the ride on the carrier vehicle. For most of persons, travel time spent between the pickup and drop off points charging the battery is sufficient to power the rest of the ride to the destination and back for the return commute. This eliminates the need to have separate charging infrastructure either at the destination or at the starting point. This is an advantage over prior art systems which require substantial new investments in new infrastructure to refuel or recharge.

A scheduler system coordinates all the routes. The scheduler gets requests for rides from persons. Scheduler maintains a database of all active carrier vehicles as well as their geographic locations. This database is updated periodically based on the updates received from the carrier vehicle. Scheduler also maintains a database of where each carrier vehicle is headed. Based on this, the scheduler computes an optimal pickup point for each person and relays this back.

Person rides his/her personal transport vehicle to reach the pickup point and wait for the carrier vehicle. Use of a personal transport vehicle allows the commuter to cover a relatively large distance in a timely fashion. Prior-art mass transit systems that were designed with pickup points spaced closely such that commuters can walk to the pickup point. Use of a personal transport vehicle allows pickup points to be spaced farther, thereby speeding up average speed of transport whilst achieving an optimal travel time. Spacing the pickup points farther apart also allows a larger number of persons for a given carrier vehicle route, thereby increasing the occupancy of the carrier vehicles.

Use of a scheduler system allows on-demand scheduling of carrier vehicles. It also allows dynamic assignment of pickup points to maximize occupancy of carrier vehicles. This results in a more cost effective operation for the carrier vehicle. It also results in a more optimal commute time for the commuters.

Accordingly one embodiment comprises the following:
(a) Carrier Vehicle
(b) Personal Transport Vehicle
(c) Application software on a Smartphone
(d) Scheduler system

Each of these components will now be described, followed by a detailed description of the operation of the system.

### Carrier Vehicle

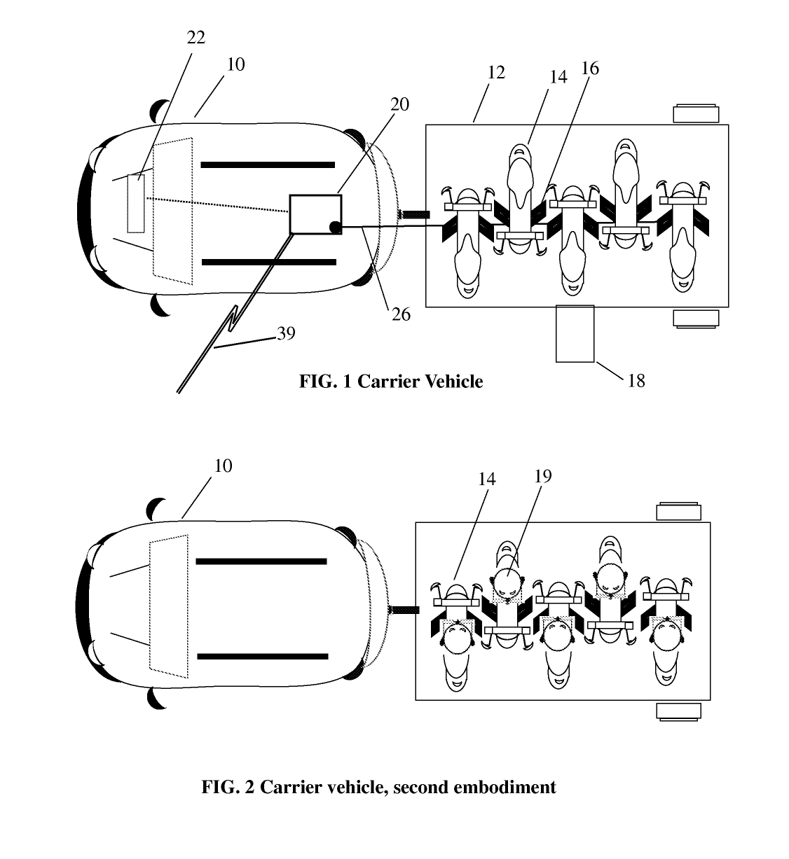

One embodiment of a carrier vehicle is shown in FIG. 1. Carrier vehicle is capable of transporting persons as well as personal transport vehicles. According to one embodiment, the battery on the personal transport vehicles are charged while on the carrier vehicle.

Carrier vehicle comprising passenger van 10 with an attached trailer 12. Trailer 12 has a docking mechanism 16 to physically secure personal transport vehicles.

As mentioned earlier, carrier vehicle has a battery charger means 26 that is connected via a charging pod to the personal transport vehicle 14. In another embodiment charging interface may be combined in the same assembly as the docking mechanism 16.

Carrier vehicle also has a control unit 20 that comprises following functions:
(a) Provide a control interface means to connect to the corresponding mating interface on the personal transport vehicle. This interface is used to query and collect information including the serial number of the attached personal transport vehicle and status of the battery. Collected information may be transmitted to the scheduler system via the data communications connection.
(b) Control interface also monitors and logs the amount of charge dispensed. This is also logged and may be used for later billing purposes.
(c) The control unit also establishes a secure networking connection 39 to the scheduler system.
(d) Additionally, the control unit has a display and input interface 22 to the driver of the carrier vehicle to allow directions from the scheduler system to be presented. Carrier vehicle may be manually driven by a human driver. In an alternate embodiment, carrier vehicle may be a driver-less vehicle driven under computer control.

Carrier vehicle has means to determine its own geographic location using methods such as Global Position System (GPS). Carrier vehicle exchanges data with the scheduler system using wireless data communications network. Said carrier vehicle communicates periodically with the scheduling system to convey its location as well as occupancy information. The scheduling system in turn gives directions to the driver of the carrier vehicle as to which route to follow.

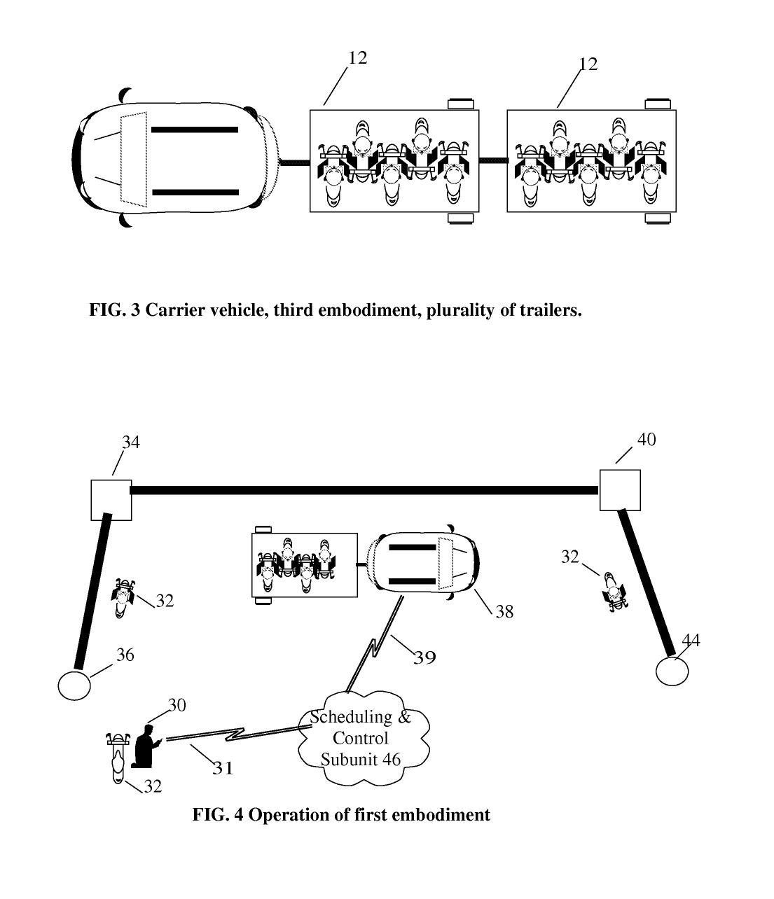

In the first embodiment shown, carrier vehicle has two parts, passenger van 10 is attached to a trailer 12. Trailer 12 carries personal transport vehicles whilst recharging them. Passenger van 10 is used to seat the persons. According to a second embodiment shown in FIG. 2 both persons and their personal transport vehicles use the same area of the carrier vehicle. In a third embodiment shown in FIG. 3 plurality of trailers are attached and hauled by a single van means.

First embodiment described here uses roadways. Alternate embodiments of carrier vehicles use railway, airway, or waterway or a combination thereof.

### Personal Transport Vehicle

Personal Transport Vehicle is used by said person to reach the pickup point as well as from the drop off point to his/her destination. In one embodiment personal transport vehicles are used by one person. Alternate embodiments can be used to transport plurality of persons. Personal Transport Vehicle is powered by a rechargeable battery. Personal transport vehicle has a charging and control interface through which the battery can be charged and recharged. It further comprises an onboard computer that can communicate via the control interface to convey remaining charge on the battery, unique serial number and other information. According to an alternate embodiment the battery on the personal transport vehicle is replaced with a charged battery at the pickup point or on the carrier vehicle instead of re-charging an existing battery. The personal transport vehicle also has a docking means to attach it to the carrier vehicle.

### Smartphone Application Software

This is a software application resident in a smartphone and used by a person. Software application allows persons to specify and request a ride to his/her desired destination. Smartphone application has access to the current physical location by using the Global Positioning System (GPS) function of the smartphone. The application then sets up a secure communication channel to the scheduler using a wireless data network. It then sends the request to the scheduler system with a desired destination, person's identity, and current physical location. When a response is received from the scheduling sub-system, the application software presents this to the person on the smartphone display. Response from the scheduler system includes pickup point, expected pickup time, and drop-off point.

### Communications Sub-System

The communication sub-system is a wireless data networking system that connects the scheduler system to plurality of travelling persons via their smart phone applications and to the plurality of carrier vehicles.

### Scheduler System

According to the one embodiment scheduler system is a software application that resides in a plurality of server computers comprising the following:
(a) A database with detailed map and routes of the geographic area being served
(b) Means to collect requests from commuters including their user identification, current geographic location and their desired destination.
(c) Means to collect periodic updates from a plurality of carrier vehicles including their serial number identification, occupancy, and geographic location.
(d) Algorithm means to compute an optimal pickup point and re-compute routes of carrier vehicles to meet goals comprising:
   (e) Maximize occupancy of carrier vehicles, ensuring empty seats on carrier vehicles is used up.
   (f) Overall commute times for each commuter meets or exceeds pre-set criteria for overall commute time.
   (g) Distance travelled by the commuter to reach the pickup point does not exceed preset criteria.
   (h) Minimize operational cost of carrier vehicles by reducing distance travelled.
   (i) Reduce overall commute times by using areas with less traffic and higher speed limits, whilst meeting other preset criteria for commuter service.
(j) Algorithm means to implement on-demand scheduling of carrier vehicles based on incoming commuter requests whereby carrier vehicles are activated if needed.
(k) Collect information for the distance travelled as well as the amount of battery charge delivered to the personal transport vehicle for billing purposes.

### Operation

An embodiment of the operation is shown in FIG. 4. For the sake of explanation, the figure illustrates the operation for one travelling person and one carrier vehicle. In reality, there are a plurality of persons and carrier vehicles.
(a) Person 30 at the starting point 36 wishes to travel to his/her destination 44. He/she uses an instance of application software on a smartphone. Said application has a user interface that lets the person input his/her desired destination. Said application then sends this request via the communication subunit 31 to the scheduler system.
(b) As described in the section on Scheduler system the scheduler 46 computes the optimal pickup point for the person and communicates this back to the person via the application software and displayed on the smartphone. Additionally, expected pickup time and the recommended drop-off point will also be displayed.
(c) Person 30 reaches the pickup point 34 by riding his/her personal transport vehicle 32. And waits for the carrier vehicle 38.

Once the carrier vehicle 38 arrives, person 30 loads his/her personal transport vehicle on to the carrier vehicle 38 securing it with the docking means. Carrier vehicle 38 starts recharging the battery on the personal transport vehicle 32 and also queries the personal transport vehicle and sends information including the serial number of personal transport vehicle, amount of charge transferred to the scheduler 39. This information also allows the scheduler to compute the occupancy of each carrier vehicle.
(d) Person 30 also travels on the same carrier 38 vehicle in the designated seating area.
(e) Person 30 disembarks at the drop-off point 40 and also unloads his/her personal transport vehicle 32. He/she covers the remainder of the distance to the destination 44 by riding the personal transport vehicle 32.
(f) The above procedure is repeated and managed by the scheduler system on a plurality of persons and carrier vehicles.

### ALTERNATIVE EMBODIMENTS

According to an alternate embodiment, carrier vehicles use roadways, water ways or air ways to travel.

According another embodiment carrier vehicles carry personal transport vehicles that do not need to be recharged.

According another embodiment, carrier vehicle has extra space to carry persons who travel without their personal transport vehicles.

### CONCLUSION, RAMIFICATIONS, AND SCOPE

From the description above, a number of advantages of at least one embodiment of my transportation system become evident:
(a) Persons and personal transport vehicles travel together on the carrier vehicle thereby eliminating the need for parking at intermediate points as required in prior art solutions. Consequently cost of parking, time spent in parking and walking from and to parking are also saved. Problems associated with theft of parked vehicle are also eliminated.
(b) Personal transport vehicle is recharged during the ride on the carrier vehicle thereby eliminating the need for separate recharging infrastructure needed by prior art solutions.
(c) Size of the battery on the personal transport vehicle is determined by the distance travelled between charges. Prior art solutions require a substantially longer distance to be covered and consequently a bigger battery depending on the availability of recharging infrastructure. In the embodiments discussed here, battery size is substantially smaller since the battery is charged every time a person rides on the carrier vehicle. This enables a smaller and lower cost personal transport vehicle.
(d) Average fuel spent is much lower for one or more embodiments described compared to each commuter driving own car or even a set of passengers using a car pool. This results in savings in both money and reduction of pollution.
(e) In the present embodiment, a person uses the personal transport vehicle only to reach the pickup point. This is usually a small fraction of the overall commute and usually on the smaller approach roads rather than highways. Since the person is not driving when he/she is travelling on the carrier vehicle, stress of driving in congested traffic is avoided. Driving the personal transport vehicle only on the smaller roads and for a relatively short distances makes it both safer and of shorter duration.
(f) According to a report by Brookings institute cited in reference (b), 74% of commuters in the USA commute alone to work by car. Current embodiment uses a carrier vehicle to carry plurality of persons. Widespread use of one or more embodiments will reduce the number of vehicles on the roads, thereby reducing traffic congestion. It will also reduce pollution levels and average fuel spent per person.
(g) It does not require costly investments for new infrastructure whilst improving travel times. In fact, it reduces use of existing infrastructure such as roads by reducing the number of vehicles on the road. It also frees parking spaces setup for prior-art solutions that can now be put to alternate uses.
(h) Due to use of personal transport vehicles, carrier vehicle routes can be configured with pick up points spaced farther apart compared to prior-art mass transit systems. Carrier vehicles do not have to make as many stops to cover a given distance, thereby reducing overall commute times. This also allows more commuters to share smaller number of carrier vehicle routes, thereby enabling the scheduler system to increase the occupancy of the carrier vehicles thereby increasing profitability.

While my above description contains many specificities, these should not be construed as limitations on the scope, but rather as an exemplification of one or more embodiments thereof.

Accordingly, the scope should be determined not by the embodiments illustrated, but by the appended claims and their legal equivalents.

I claim:

1) A transportation system comprising:
at least a self-propelled carrier vehicle configured to carry at least a person and at least a personal transport vehicle with means to charge the battery on said personal transport vehicle;
at least a self-propelled personal transport vehicle configured to carry at least said person;
at least an instance of smartphone application means communicably attached to a scheduler system thereby enabling said person to interact with said scheduling system;
said scheduler system communicably attached to at least said carrier vehicle and at least said instance of smartphone application thereby enabling scheduling of said carrier vehicles and said persons.

2) Transportation system of claim 1 wherein said carrier vehicle further comprises a control module comprising:
means to measure and log amount of charge dispensed to said battery of said personal transport vehicle;
connectivity means to said personal transport vehicles to receive data including vehicle serial number, battery charge status;
graphical display and input means to the driver of said carrier vehicle;
data networking means to operatively establish a secure connection to said scheduler system thereby receiving directions from the scheduler and transmitting data including current GPS location, data collected from personal transport vehicles, and occupancy.

3) Transportation system of claim 1 wherein said carrier vehicle further comprises a ramp means operatively coupled to said carrier vehicle thereby enabling persons and personal transport vehicles to get on and off said carrier vehicle.

4) Transportation system of claim 1 wherein said carrier vehicle further providing transportation on roadway, railway, waterway, airway or a combination thereof.

5) Transportation system of claim 1 wherein said carrier vehicle is driverless and driven substantially by automated computer means.

6) Transportation system of claim 1 wherein said personal transport vehicle comprises:
at least a rechargeable said battery;
docking means to releasably attach to said carrier vehicle;
charging input connectivity means whereby said battery is recharged;
control interface means operatively attached to configuration data including vehicle serial number, charge status of said battery.

7) Transportation system of claim 1 wherein said smartphone application is configured to receive from user and send to said scheduler data comprising current GPS location, and desired destination; receive and display data from said scheduler system comprising pickup point, estimated pickup time, and drop-off point.

8) Transportation system of claim 1 wherein said scheduler system comprising a scheduling function operatively connected via a secure internet connections to plurality of said carrier vehicles and plurality of said instances of application software program on smart phones.

9) Scheduler system of claim 8 further comprising means to receive and send data from plurality of users via smartphone application; means to receive and send data from plurality of carrier vehicles; algorithm means to compute optimal schedule for said carrier vehicles and said persons.

10) Scheduler system of claim 8 wherein said scheduling function is a stored program sequence executed on a plurality of interconnected server computing devices.

11) A method of transportation of comprising:
a) receiving requests for travel from at least a person with at least a desired destination and current GPS location information;
b) scheduler system providing response to said person including a pickup point, a drop-off point, and an expected pickup time information;
c) upon receiving information on said pickup point, person using said personal transport vehicle to reach said pickup point;
d) carrier vehicle transporting person and personal transport vehicle from said pickup point to said drop-off point;
e) carrier vehicle charging said battery on said personal transport vehicle between said pickup and said drop-off points;
f) said person using said personal transport vehicle to travel from said drop-off point to said desired destination;
g) said scheduler system receiving periodic and on demand communication from plurality of carrier vehicles comprising current GPS location, and occupancy;
h) said scheduler system computing optimal pickup point for each request from persons such that travel time meets preset criteria and meets preset criteria for occupancy of said carrier vehicles;
i) said scheduler system sending route information to said carrier vehicles.
